(19) United States
(12) Patent Application Publication
(10) Pub. No.: US 2010/0303151 A1
(43) Pub. Date: Dec. 2, 2010

(54) Method for decoding video signal encoded using inter-layer prediction

(76) Inventors: Byeong Moon Jeon, Seoul (KR); Seung Wook Park, Seoul (KR); Ji Ho Park, Seoul (KR)

Correspondence Address: HARNESS, DICKEY & PIERCE, P.L.C., P.O. BOX 8910, RESTON, VA, 20195, US

(21) Appl. No.: 12/662,541

(22) Filed: Apr. 22, 2010

Related U.S. Application Data
(63) Continuation of application No. 11/918,214, filed on Oct. 14, 2008.
(60) Provisional application No. 60/662,372, filed on Mar. 17, 2005.
(60) Provisional application No. 60/668,575, filed on Apr. 6, 2005.

(30) Foreign Application Priority Data
Aug. 22, 2005 (KR) 10-2005-0076817

(51) Int. Cl. H04N 7/32

(52) U.S. Cl. 375/240.12; 375/E07.243

(57) ABSTRACT

A method for receiving and decoding an encoded bitstream of a first layer and an encoded bitstream of a second layer into a video signal is provided. It is determined whether or not a block temporally coincident with a target block in a picture of the first layer is present in the bitstream of the second layer. An operation for checking information (intra_base_flag and residual_prediction_flag) indicating whether or not the target block has been predicted based on data of a block in a different layer corresponding to the target block is skipped if no block temporally coincident with the target block is present in the bitstream of the second layer. This method eliminates the need for encoders to transmit unnecessary information (intra_base_flag and residual_prediction_flag) when performing inter-layer prediction using a temporally adjacent frame.

### 1. TECHNICAL FIELD

The present invention relates to a method for decoding a video signal encoded using inter-layer prediction.

### 2. BACKGROUND ART

Scalable Video Codec (SVC) encodes video into a sequence of pictures with the highest image quality while ensuring that part 10 of the encoded picture sequence (specifically, a partial sequence of frames intermittently selected from the total sequence of frames) can be decoded and used to represent the video with a low image quality. Motion Compensated Temporal Filtering (MCTF) is an encoding scheme that has been suggested for use in the scalable video codec.

Although it is possible to represent low image-quality video by receiving and processing part of a sequence of pictures encoded according to the scalable MCTF scheme, there is still a problem in that the image quality is significantly reduced if the bitrate is lowered. One solution to this problem is to provide an auxiliary picture sequence for low bitrates, for example, a sequence of pictures that have a small screen size and/or a low frame rate.

The auxiliary picture sequence is referred to as a base layer, and the main frame sequence is referred to as an enhanced or enhancement layer. Video signals of the base and enhanced layers have redundancy since the same video signal source is encoded into two layers. As illustrated in FIG. 1A, to increase the coding efficiency of the enhanced layer, one method codes information regarding a motion vector of a macroblock in an enhanced layer picture using information of a motion vector of a corresponding block in a base layer picture temporally coincident with the enhanced layer picture (S10 and S12). Another method codes a macroblock in a video frame of the enhanced layer based on a temporally coincident video frame of the base layer and transmits information regarding the coding type (S15 and S18). Specifically, when the current block in the enhanced layer is an intra-mode block, a flag “intra_base_flag”, which indicates whether or not the current macroblock has been coded into difference data from image data of an intra-mode block in the base layer corresponding to the current macroblock, is transmitted (S15). When the current block in the enhanced layer is an inter-mode block, a flag “residual_prediction_flag”, which indicates whether or not residual data of the current block has been coded into residual difference data from residual data of a corresponding block in the base layer, is transmitted (S1B).

An encoder encodes each macroblock of a video signal according to a procedure as shown in FIG. 1A, and sets and transmits a flag “base_id_plus1” in a slice header, thereby allowing a decoder to decode each macroblock of frames using prediction information of the base layer according to the procedure of FIG. 1A.

On the other hand, when no frame temporally coincident with a current frame for encoding is present in the base layer, the encoder encodes each macroblock of a current frame according to a procedure as shown in FIG. 1B, in which the encoder determines a suitable block mode for each macroblock of the current frame (S21), generates prediction information of the macroblock according to the determined block mode (S22), and codes data of the macroblock into residual data (S23). When the procedure of FIG. 1B is performed, a flag “base_id_plus1” is reset and written in a slice header. This notifies the decoder that inter-layer prediction has not been performed, thereby allowing the decoder to decode each macroblock of a corresponding slice according to the decoding procedure of FIG. 1B rather than the decoding procedure of FIG. 1A.

As described above, when no frame temporally coincident with the current frame of the enhanced layer is present in the base layer, inter-layer prediction is not performed and any information regarding inter-layer prediction such as the flags BLflag, QReFlag, and intra_base_flag is not transmitted. In this case, the flag “base_id_plus1” is reset and transmitted, so that the decoder does not refer to information regarding inter-layer prediction and also does not perform inverse inter-layer prediction.

However, enhanced and base layer frames, which have a short time interval therebetween although they are not temporally coincident, will be likely to be correlated with each other in motion estimation of macroblocks since they are temporally close to each other. This indicates that, even for enhanced layer frames having no temporally coincident base layer'frames, it is possible to increase the coding efficiency using motion vectors of base layer frames temporally adjacent to the enhanced layer frames since the temporally adjacent enhanced and base layer frames are likely to have similar motion vectors.

A method for performing inter-layer prediction even for enhanced layer frames having no temporally coincident base layer frames has been suggested in view of these circumstances. One example is an inter-layer prediction method in which a motion vector of a current macroblock in an enhanced layer frame is predicted from a motion vector of a co-located block, corresponding to the current macroblock, in a temporally adjacent base layer frame which is not temporally coincident with the enhanced layer frame but which is temporally close thereto. Specifically, the motion vector of the co-located block in the base layer frame is scaled by the ratio of the resolution of pictures in the enhanced layer to the resolution of pictures in the base layer, and a motion vector of the current macroblock is derived by multiplying the scaled vector by a suitable ratio (for example, the ratio of the time interval between frames in the enhanced layer to the time interval between frames in the base layer).

As can be seen from FIGS. 1A and 1B, a flag “base_id_plus1” must be set and transmitted to allow the decoder to reconstruct, through inverse inter-layer prediction, an enhanced layer frame having blocks that have been encoded through prediction based on a base layer frame which is not temporally coincident with the enhanced layer frame and which is temporally adjacent thereto. When the flag “base_id_plus1” is set and transmitted, the decoder decodes a received frame according to the procedure of FIG. 1A. Therefore, when the flag “base_id_plus1” is set aria transmitted, a flag “intra_base_flag” must be transmitted for an intra mode block and a flag “residual_prediction_flag” must be transmitted for an inter mode block.

However, the two flags “intra_base_flag” and “residual_prediction_flag”, which are flags for use in prediction based on a frame temporally coincident with a current frame, are not used for prediction based on a frame temporally adjacent with the current frame. Thus, transmitting the two flags for blocks encoded through prediction based on temporally adjacent frames unnecessarily increases the amount of information to be transmitted. Accordingly, it is desirable that the encoder not transmit the two flags.

However, when the encoder does not transmit the two flags “intra_base_flag” and “residual_prediction_flag” for blocks encoded through prediction based on temporally adjacent frames, the current decoding methods cannot decode the blocks. If the encoding method, in which the two flags “intra_base_flag” and “residual_prediction_flag” are not transmitted, is employed, one of the two flags is transmitted for blocks encoded through prediction from a temporally coincident frame whereas none of the two flags are transmitted for blocks encoded through prediction from a temporally adjacent frame. However, the current decoding methods cannot distinguish between blocks encoded through prediction from a temporally coincident frame and blocks encoded through prediction from a temporally adjacent frame, thereby causing decoding errors. One could conceive an encoder that inserts, in a header of a slice, a new flag that allows the decoder to determine whether or not one of the two flags has been transmitted for blocks in the slice. However, this requires that the encoder transmit additional information regarding the new flag.

### 3. DISCLOSURE OF INVENTION

Therefore, the present invention has been made in view of the above problems, and it is an object of the present invention to provide a method for decoding a video signal, which can distinguish between inter-layer prediction based on a temporally coincident frame and inter-layer prediction based on a temporally adjacent frame, thereby eliminating the need for an encoder to transmit unnecessary information for inter-layer prediction based on a temporally adjacent frame.

In accordance with the present invention, the above and other objects can be accomplished by the provision of a method for receiving and decoding an encoded bitstream of a first layer and an encoded bitstream of a second layer into a video signal, the method comprising the steps of a) deciding whether to perform or skip an operation for checking information indicating that a target block in a picture of the first layer has been predicted from motion information of a block in a picture of the second layer not temporally coincident with the target block, and performing the operation for checking the information indicating that the target block has been predicted from the motion information, according to the decision, and b) determining whether or not a block temporally coincident with the target block is present in the bitstream of the second layer and skipping an operation for checking information regarding the target block, indicating whether or not the target block has been predicted based on data of a block in a different layer corresponding to the target block, if no block temporally coincident with the target block is present in the bitstream of the second layer.

In an embodiment of the present invention, it is decided to perform the operation for checking the information indicating that the target block has been predicted from the motion information if no corresponding block temporally coincident with the target block is present in the second layer and a co-located block, corresponding to the target block, in a picture of the second layer temporally adjacent to the target block has not been coded in an intra mode.

### 4. BRIEF DESCRIPTION OF DRAWINGS

The above and other objects, features and other advantages of the present invention will be more clearly understood from the following detailed description taken in conjunction with the accompanying drawings, in which:

FIG. 1A is a flow chart illustrating how a macroblock is decoded when inter-layer prediction is employed;

FIG. 1B is a flow chart illustrating how a macroblock is 30 decoded when no inter-layer prediction is employed;

FIG. 2 is a block diagram of a decoding apparatus that performs a decoding method according to the present invention;

FIG. 3 illustrates main elements of an MCTF decoder shown in FIG. 2 that performs the decoding method according to the present invention;

FIG. 4 is a flow chart illustrating how a macroblock is decoded according to the present invention; and

FIG. 5 illustrates how a position difference “DiffPoC” used to decide whether to check flags is calculated according to the present invention.

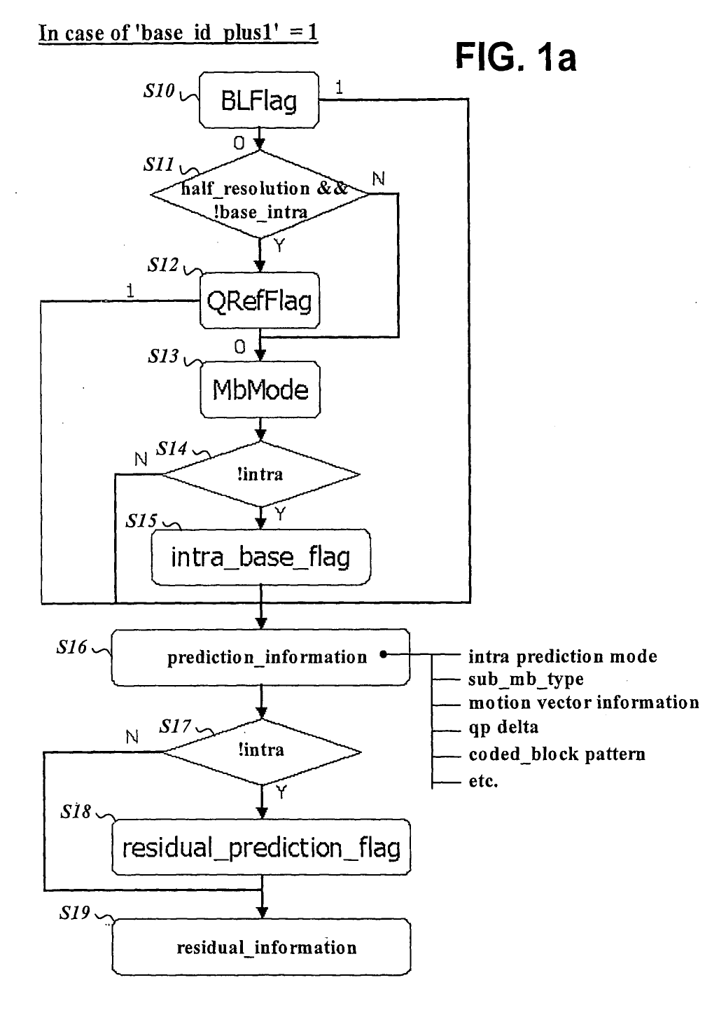

### 5. MODES FOR CARRYING OUT THE INVENTION

Preferred embodiments of the present invention will now be described in detail with reference to the accompanying drawings.

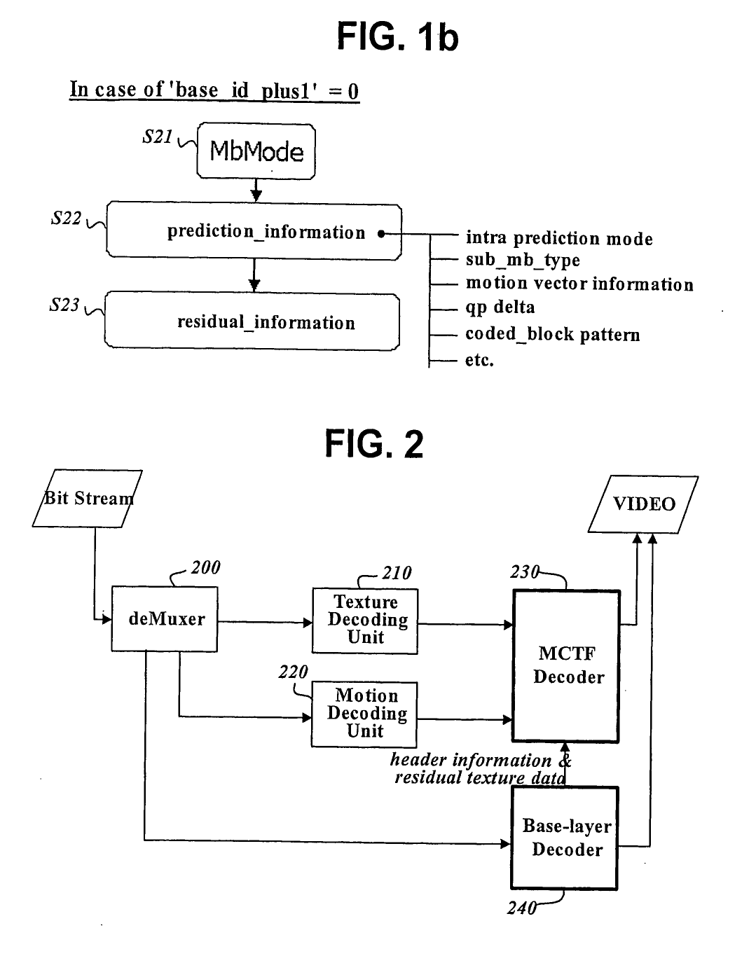

FIG. 2 is a block diagram of an apparatus for decoding an encoded data stream. The decoding apparatus of FIG. 2 includes a demuxer (or demultiplexer) 200, a texture decoding unit 210, a motion decoding unit 220, an MCTF decoder 230, and a base layer (BL) decoder 240. The demuxer 200 separates a received data stream into a compressed motion vector stream, a compressed macroblock information stream, and a base layer stream. The texture decoding unit 210 reconstructs the compressed macroblock information stream to its original uncompressed state. The motion decoding unit 220 reconstructs the compressed motion vector stream to its original uncompressed state. The MTCF decoder 230 is an enhanced layer (EL) decoder that converts the uncompressed macroblock information stream and the uncompressed motion vector stream back to an original video signal according to an MCTF scheme. The BL decoder 240 decodes the base layer stream according to a specified scheme, for example, according to the MPEG-4 or H.264 standard. The BL decoder 240 not only decodes an input base layer stream but also provides a header in the stream to the EL decoder 230 to allow the EL decoder 230 to use necessary encoding information of the base layer included in the header, for example, motion vector-related information. The BL decoder 240 also provides residual texture data of each encoded base layer picture to the MCTF decoder 230.

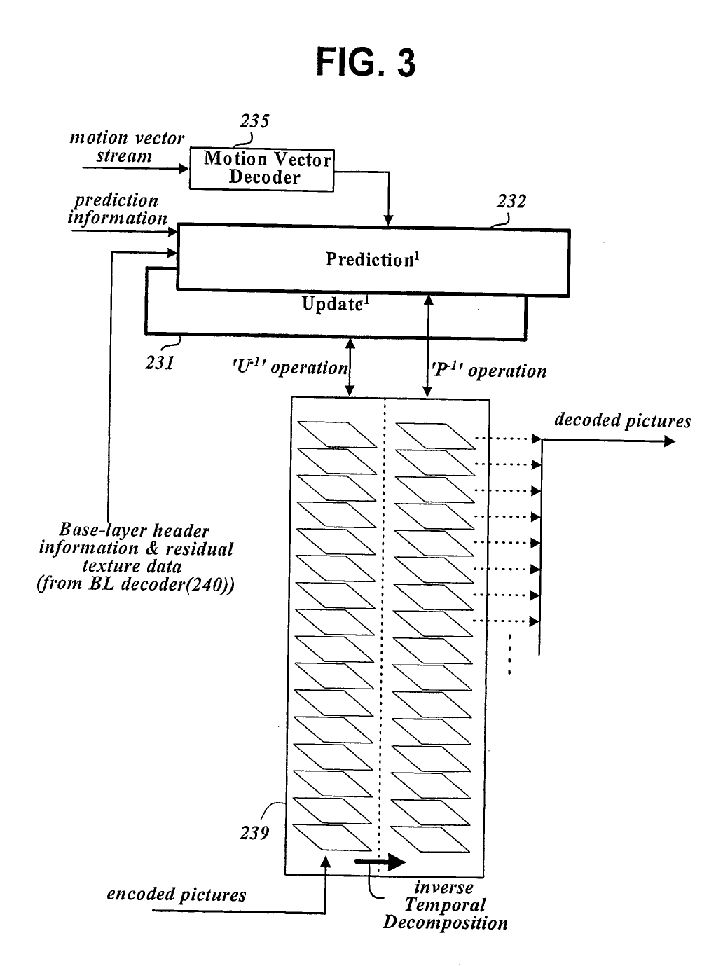

The MCTF decoder 230 is a simple example of the EL decoder used when receiving streams of a plurality of layers. The MCTF decoder 230 includes elements of FIG. 3 that perform a temporal decomposition procedure to reconstruct an original video frame sequence from an input stream. A decoding method according to the present invention, which will be described below, is applied not only to the MCTF scheme but also to any other encoding/decoding scheme that uses inter-layer prediction.

The elements of FIG. 3 include an inverse updater 231, an inverse predictor 232, and a motion vector decoder 235. The inverse updater 231 selectively subtracts difference values (residuals) of pixels of H pictures received and stored in a storage 239 from L pictures previously received and stored in the storage 239. The inverse predictor 232 reconstructs the H pictures received and stored in the storage 239 to L pictures having original images based on the above L pictures from which the image differences of the H pictures have been subtracted. The motion vector decoder 235 decodes an input motion vector stream into motion vector information of blocks in H pictures and provides the motion vector information to the inverse predictor 232. The inverse updater 231 and the inverse predictor 232 may perform their operations on a plurality of slices, which are produced by dividing a single frame, simultaneously and in parallel, instead of performing their operations on the video frame. In the description of the present invention, the term “picture” is used in a broad sense to include a frame or slice, provided that replacement of the, term “picture” with the term “frame” or “slice” is technically equivalent.

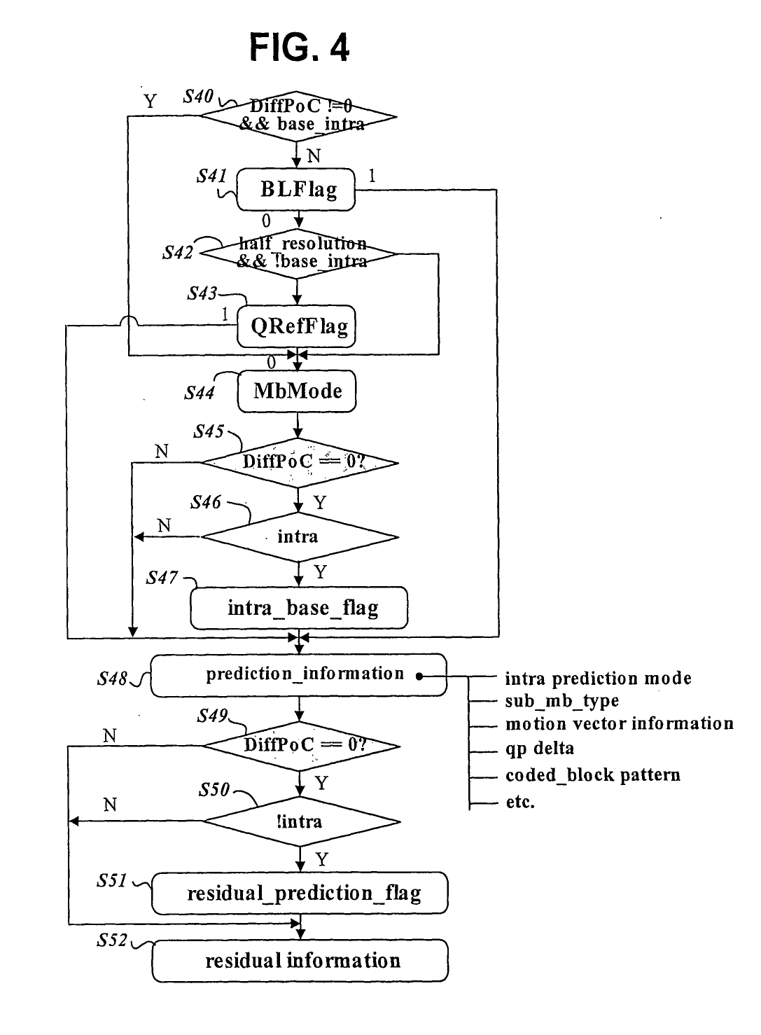

The inverse predictor 232 performs a procedure illustrated in FIG. 4 according to the present invention, which is part of the decoding procedure for reconstructing received and stored H pictures to pictures having original images. The following is a detailed description of the procedure of FIG. 4.

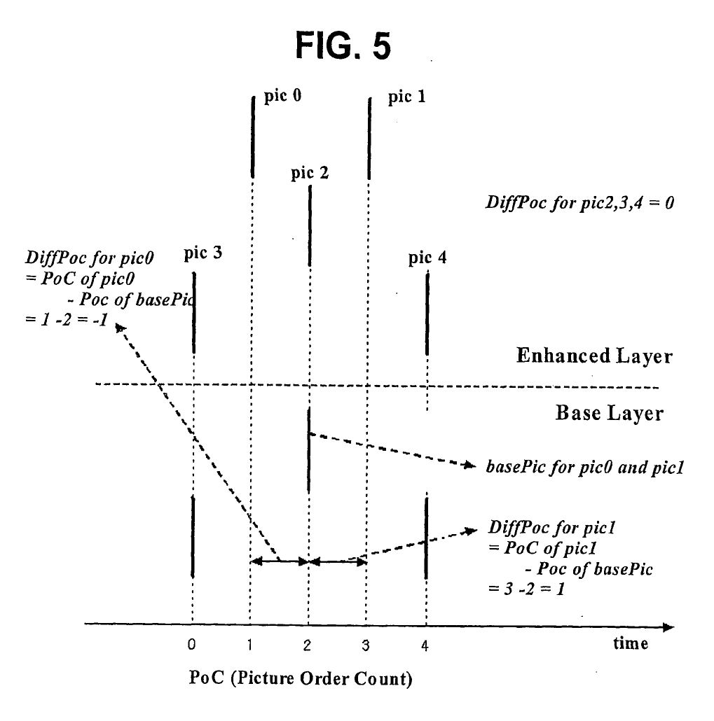

The inverse predictor 232 performs the procedure of FIG. 4 on each received and stored picture (or slice) when a base_id_plus1 flag in a header of the picture (or slice) is nonzero. Before checking information regarding the motion vector of each macroblock in a current H picture, the inverse predictor 232 determines a position difference “DiffPoC” between the current H picture and a picture in a base layer temporally closest to the current H picture (S40). The position difference “DiffPoC” is the time difference between the current H picture and the base layer picture and is expressed by a positive or negative value as illustrated in FIG. 5, and time information of each picture in the base layer can be determined from header information provided from the BL decoder 240.

When the position difference “DiffPoC” is zero, i.e., if a base layer picture temporally coincident with the Current H picture is present, the inverse predictor 232 checks a flag “BLFlag” as in the conventional method (S41). If the flag “BLFlag” is 1, the inverse predictor 232 obtains a scaled motion vector E_mvBL by scaling a motion vector mvBL of a corresponding block in an H picture in the base layer temporally coincident with the current H picture by the ratio of the resolution of pictures in the enhanced layer to the resolution of pictures in the base layer, i.e., by scaling the x and y components of the motion vector mvBL up 200%. Then, the inverse predictor 232 regards the scaled motion vector E_mvBL (or the scaled motion vector E_mvBL multiplied by an inter-layer frame interval ratio) as the motion vector of the current macroblock and specifies a reference block of the current macroblock using the scaled motion vector E_mvBL. Here, the term “inter-layer frame interval ratio” refers to the ratio of the time interval between frames (or pictures) in the enhanced layer to the time interval between frames in the base layer.

If the flag “BLFlag” is zero, the inverse predictor 232 determines whether or not the resolution of the base layer differs from that of the enhanced layer and the corresponding block is a non-intra-mode block (S42). If the determination at step S42 is yes (i.e., the resolution of the base layer differs from that of the enhanced layer and the corresponding block is a non-intra-mode block), the inverse predictor 232 checks a flag “QRefFlag” (S43), otherwise it determines a motion vector of the current macroblock according to a known method and specifies a reference block of the current macroblock based on the determined motion vector (S44).

If the checked flag “QRefFlag” is 1, the inverse predictor 232 checks vector refinement information of the current macroblock provided from the motion vector decoder 235, and determines a compensation (or refinement) vector according to an x and y refinement value included in the checked vector refinement information. The inverse predictor 232 obtains an actual motion vector of the current macroblock by adding the determined compensation vector to the scaled motion vector E_mvBL (or to the scaled motion vector E_mvBL multiplied by the interlayer frame interval ratio) and specifies a reference block of the current macroblock using the obtained actual motion vector. If the flag “QRefFlag” is zero, the inverse predictor 232 determines a motion vector of the current macroblock according to a known method and specifies a reference block of the current macroblock using the determined motion vector (S44).

Even when the position difference “DiffPoC” determined at step S40 is nonzero, the inverse predictor 232 performs the procedure of steps S41, 542, and S43, which use the motion vector information of the base layer, if a block in the base layer, corresponding to the current macroblock, is a non-intra-mode block. When no temporally coincident picture is present in the base layer, the corresponding block is a block, co-located with the current macroblock, in a temporally closest picture in the base layer. In the following description of the present invention, the term “corresponding block” is used to include not only a corresponding block in a base layer picture temporally coincident with the current picture but also a co-located block in a base layer picture temporally closest thereto. In this procedure, motion vector information of the co-located block in the temporally closest base layer picture rather than in the temporally coincident base layer picture is used in the same manner as described above. This allows the encoder to encode prediction information using base layer motion vectors, regardless of whether or not a picture temporally coincident with the current picture is present in the base layer, and then to transmit the encoded prediction information to the decoder.

On the other hand, if the position difference “DiffPoC” determined at step S40 is nonzero and the block in the base layer, corresponding to the current macroblock, is an intra-mode block, motion vector information of the corresponding block in the base layer cannot be used, and thus the inverse predictor 232 proceeds to the next series of steps to decide whether to refer to prediction information of texture data.

The inverse predictor 232 checks the position difference “DiffPoC” which has been determined at step 540 (S45). If the position difference “DiffPoC” is zero, i.e., if a temporally coincident picture is present in the base layer, the inverse predictor 232 determines whether or not the current macroblock is an intra-mode block as in the conventional method (S46). If the current macroblock is an intra-mode block, the inverse predictor 232 checks a flag “intra_base_flag” that indicates whether or not the current macroblock has been coded based on an image of a corresponding block temporally coincident with the current macroblock (S47). Depending on the checked value of the flag “intra_base_flag”, the inverse predictor 232 reconstructs precoding data of the current macroblock based on reconstructed image of the corresponding block or based on values of pixels adjacent to the current macroblock. If it is determined at step S46 that the current macroblock is not an intra-mode block, the inverse predictor 232 skips step S47 since it is meaningless to perform the step S47 of checking the flag “intra_base_flag” that is provided to allow the current macroblock in the enhanced layer to use a corresponding block in the base layer when the corresponding block has been intra-coded.

If it is determined at step S45 that the position difference “DiffPoC” is nonzero, the inverse predictor 232 also skips step S47, regardless of whether or not the current macroblock has been intra-coded, since it is meaningless to perform the step S47 of checking the flag “intra_base_flag” that is provided to allow the current macroblock in the enhanced layer to use a corresponding block, temporally coincident with the current macroblock, in the base layer when the corresponding block has been intra-coded. That is, the inverse predictor 232 skips the step S47 of checking the flag “intra_base_flag” if the position difference “DiffPoC” is nonzero since the encoder performs intra-mode coding on a macroblock, to which motion estimation is not applied, and does not perform predictive coding on the macroblock based on a base layer picture if no temporally coincident picture is present in the base layer. In this case, since the inverse predictor 232 skips the step of checking the flag “intra_base_flag” based on the position difference “DiffPoC”, there is no need for the encoder to transmit the flag “intra_base_flag” even when setting and transmitting the flag “base_id_plus1”.

Next, the inverse predictor 232 rechecks the position difference “DiffPoC” which has been determined at step S40 (S49). If the position difference “DiffPoC” is zero, i.e., if a temporally coincident picture is present in the base layer, the inverse predictor 232 determines whether or not the current macroblock is an intra-mode block as in the conventional method (S50). If the current macroblock is not an intra-mode block, the inverse predictor 232 checks a flag “residual_prediction_flag” that indicates whether or not residual data of the current macroblock has been coded into residual difference data based on residual data of a corresponding block temporally coincident with the current macroblock (S51). Depending on the checked value of the flag “residual_prediction_flag”, the inverse predictor 232 reconstructs original residual data of the current macroblock by adding residual data of the corresponding block to data of the current macroblock or decodes received residual data of the current macroblock into pre-coding image data based on its reference block specified using the previously determined motion vector.

If it is determined at step S50 that the current macroblock is an intra-mode block, the inverse predictor 232 skips step S51 since it is meaningless to perform the step S51 of checking the flag “residual_prediction_flag” that indicates whether or not residual data of the current macroblock, coded in an inter mode, in the enhanced layer has been coded into residual difference data based on residual data of the corresponding block in the base layer.

When it is determined at step S49 that the position difference “DiffPoC” is nonzero, i.e., if no temporally coincident picture is present in the base layer, the inverse predictor 232 also skips step S51, regardless of whether or not the current macroblock has been intra-coded, since it is meaningless to perform the step S51 of checking the flag “residual_prediction_flag” that indicates whether or not residual data of the current macroblock, coded in an inter mode, in the enhanced layer has been coded into residual difference data based on residual data of the corresponding block in the base layer temporally coincident with the current macroblock. That is, the inverse predictor 232 skips the step S51 of checking the flag “residual_prediction_flag” if the position difference “DiffPoC” is nonzero since the encoder performs inter-mode coding on a motion-estimated macroblock and does not perform residual difference coding on residual data of the coded macroblock based on residual data of a corresponding block in the base layer if no temporally coincident picture is present in the base layer. In this case, since the inverse predictor 232 skips the step of checking the flag “residual_prediction_flag” based on the position difference “DiffPoC”, there is no need for the encoder to transmit the flag “residual_prediction_flag” even when setting and transmitting the flag “base_id_plus1”.

The inverse predictor 232 performs the procedure of FIG. 4 for all macroblocks of the current H picture to reconstruct the current H picture to an L frame (or a final video frame).

The decoding apparatus described above can be incorporated into a mobile communication terminal, a media player, or the like.

As is apparent from the above description, the present invention provides a method for decoding a video signal, in which inter-layer prediction based on temporally adjacent frames can be performed without reducing the coding efficiency. Thus, the method according the present invention maximizes the contribution of inter-layer prediction based on temporally adjacent frames to the increase in the coding efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for receiving and decoding an encoded bitstream of a first layer and an encoded bitstream of a second layer into a video signal, the method comprising the step of:
a) determining whether or not a block temporally coincident with a target block in a picture of the first-layer is present in the bitstream of the second layer and, if not present, skipping an operation for checking specific information regarding the target block.

2. The method according to claim 1, wherein the specific information is information indicating whether or not the target block has been predicted based on data of a block in a different layer corresponding to the target block.

3. The method according to claim 1, further comprising the step of:
deciding, before the step a), whether to perform or skip an operation for checking information indicating that the target block has been predicted from motion information of a block in a picture of the second layer not temporally coincident with the target block, and performing the operation for checking the information indicating that the target block has been predicted from the motion information, according to the decision.

4. The method according to claim 3, wherein the step of deciding whether to perform or skip the operation for checking the information indicating that the target block has been predicted from the motion information includes deciding to perform the operation for checking the information indicating
that the target block has been predicted from the motion information if no block temporally coincident with the target block is present in the second layer and a co-located block, corresponding to the target block, in a picture of the second layer temporally adjacent to the target block has not been codec in an intra mode.

5. The method according to claim 1, further comprising the step of:
deciding, before the step a), whether to perform or skip an operation for checking information indicating that the target block has been predicted from motion information of a block in a picture of the second layer not temporally coincident with the target block, and skipping the operation for checking the information indicating that the target block has been predicted from the motion information, according to the decision.

6. The method according to claim 3 or 5, wherein the information indicating that the target block has been predicted from the motion information includes first information indicating whether or not a motion vector of the target block is identical to a vector estimated from a motion vector of a block in a picture of the second layer or second information indicating whether or not refinement of the estimated vector is necessary to obtain the motion vector of the target block.

7. The method according to claim 1, wherein the specific information includes first information indicating whether or not image data of the target block has been coded into difference data based on pre-coding data of intra-coded residual data of a corresponding block in a different layer.

8. The method according to claim 7, wherein the step a)
includes skipping an operation for checking the first information if the target block has not been coded in an intra mode even when a block temporally coincident with the target block is present in the bitstream of the second layer.

9. The method according to claim 1, wherein the specific information includes second information indicating whether or not coded residual data of the target block has been recoded into difference data based on inter-coded residual data of a corresponding block in a different layer.

10. The method according to claim 9, wherein the step a) includes skipping an operation for checking the second information if the target block has been coded in an intra mode even when a block temporally coincident with the target block is present in the bitstream of the second layer.

11. The method according to claim 1, wherein the step a) includes determining whether or not a block temporally coincident with the target block in the picture of the first layer is present in the bitstream of the second layer, based on a time difference between the picture of the first layer and a corresponding picture of the second layer.
